(19) United States
(12) Patent Application Publication
(10) Pub. No.: US 2014/0346923 A1
(43) Pub. Date: Nov. 27, 2014

(54) Electrostatic Transformer

(71) Applicant: AOI Electronics Co., Ltd., Takamatsu-shi (JP)

(72) Inventors: Hiroki HAYASHI, Takamatsu-shi (JP); Masato SUZUKI, Takamatsu-shi (JP)

(73) Assignee: AOI Electronics Co., Ltd., Takamatsu-shi (JP)

(21) Appl. No.: 14/284,000

(22) Filed: May 21, 2014

(30) Foreign Application Priority Data
May 22, 2013 (JP) 2013-108276

(51) Int. Cl. H02N 1/08

(52) U.S. Cl. CPC H02N 1/08
USPC 310/309

(57) ABSTRACT

An electrostatic transformer includes: a first fixed electrode; a second fixed electrode; a movable electrode displaceably supported by a flexible member within a space between the first fixed electrode and the second fixed electrode; and permanently charged films disposed on electrode surfaces of the movable electrode. And: an AC output voltage corresponding to a change in an electric charge induced at the second fixed electrode by displacing the movable electrode in response to an AC input voltage applied between the first fixed electrode and the movable electrode is extracted; and a ratio of the AC input voltage and the AC output voltage is determined based upon a ratio of an electromechanical coupling factor at an input-side electrostatic actuator, configured with the first fixed electrode and the movable electrode, and an electromechanical coupling factor at an output-side electrostatic actuator, configured with the second fixed electrode and the movable electrode.

### INCORPORATION BY REFERENCE

The disclosure of the following priority application is herein incorporated by reference: Japanese patent application No. 2013-108276 filed May 22, 2013.

### BACKGROUND OF INVENTION

1. Field of the Invention

The present invention relates to an electrostatic transformer equipped with two sets of electrostatic actuators.

2. Description of Related Art

In an art known in relation to electrostatic transformers, a booster circuit is configured by using a three-terminal comb teeth actuator manufactured through the MEMS technology (see Japanese Laid Open Patent Publication No. 2011-062024). The three-terminal comb teeth actuator described in Japanese Laid Open Patent Publication No. 2011-062024 comprises a first comb teeth actuator that includes a first comb teeth electrode and a second comb teeth electrode engaged with the first comb teeth electrode via a specific gap and a second comb teeth actuator that includes a third comb teeth electrode and a fourth comb teeth electrode engaged with the third comb teeth electrode via a specific gap. In this three-terminal comb teeth actuator, the second comb teeth electrode and the third comb teeth electrode are formed as an integrated unit so as to achieve equal extents of displacement and an output is extracted from one of the comb teeth electrodes.

To describe the booster circuit disclosed in Japanese Laid Open Patent Publication No. 2011-062024 in more specific terms, it includes two electrostatic actuators, an input-side electrostatic comb teeth actuator and an output-side electrostatic comb teeth actuator manufactured through the MEMS technology. The movable comb teeth electrodes in the two electrostatic actuators are made to interlock with each other through a mechanical link, and a DC voltage is separately applied to the output-side electrostatic comb teeth actuator or an electric field is generated via an electret for the output-side electrostatic comb teeth actuator (see FIG. 1 and FIG. 2 in Japanese Laid Open Patent Publication No. 2011-062024). The two electrostatic actuators are placed in an environment achieving a high degree of vacuum (vacuum sealing of the movable comb teeth electrodes) and an AC input is applied toward the input-side electrostatic actuator (or self-excited vibration is induced by forming a feedback circuit). In this situation, as the input-side electrostatic actuator vibrates, the output-side electrostatic actuator also vibrates, which induces an electric charge through electrostatic induction and ultimately provides a voltage boosted to a level equal to or higher than the input voltage. The output voltage thus obtained, which is an AC voltage, undergoes rectification in a circuit disposed at a subsequent stage so as to obtain a boosted DC voltage.

As the description provided above clearly indicates, when the movable comb teeth electrode in the input-side electrostatic comb teeth actuator and the movable comb teeth electrode in the output-side electrostatic comb teeth actuator are interlocked through a mechanical link, the amplitude of the movable comb teeth electrode on the input side and the amplitude of the movable comb teeth electrode on the output side are bound to match each other. This means that in order to provide a higher output voltage, it must be ensured that a sufficiently large extent of vibration occurs at the movable comb teeth electrodes even when a weak AC voltage is applied to the input side. In order to allow the movable comb teeth electrodes to vibrate to a sufficiently large extent, in turn, the spring constant (see FIG. 3 and paragraph 0032 in Japanese Laid Open Patent Publication No. 2011-06024) must be lowered so as to increase the Q value of the circuit and the movable comb teeth electrodes need to be vacuum sealed so as to minimize the air resistance.

### SUMMARY OF THE INVENTION

However, this type of electrostatic transformer known in the related art is designed on the assumption that it is to be configured with electrostatic comb teeth actuators manufactured by adopting the MEMS technology and the use of such electrostatic comb teeth actuators is bound to lead to more complicated manufacturing processes and an increase in the manufacturing costs. In addition, it is difficult to manufacture a high-output, low cost electrostatic transformer configured with electrostatic comb teeth actuators manufactured by adopting the MEMS technology.

According to the 1st aspect of the present invention, an electrostatic transformer, comprises: a first fixed electrode; a second fixed electrode disposed at a position facing opposite the first fixed electrode; a movable electrode displaceably supported by a flexible member within a space between the first fixed electrode and the second fixed electrode; and permanently charged films disposed on electrode surfaces of the movable electrode or disposed at the first fixed electrode and at the second fixed electrode, wherein: an AC output voltage corresponding to a change in an electric charge induced at the second fixed electrode by displacing the movable electrode in response to an AC input voltage applied between the first fixed electrode and the movable electrode is extracted; and a ratio of the AC input voltage and the AC output voltage is determined based upon a ratio of an electromechanical coupling factor at an input-side electrostatic actuator, configured with the first fixed electrode and the movable electrode, and an electromechanical coupling factor at an output-side electrostatic actuator, configured with the second fixed electrode and the movable electrode.

According to the 2nd aspect of the present invention, in the electrostatic transformer according to the 1st aspect, it is preferred that an electrode surface facing opposite the first fixed electrode, among the electrode surfaces of the movable electrode, takes on either a flat electrode structure that allows a distance between the first fixed electrode and the movable electrode to be varied or a comb teeth electrode structure that allows the movable electrode to be displaced parallel to the first fixed electrode.

According to the 3rd aspect of the present invention, in the electrostatic transformer according to the 2nd aspect, it is preferred that: the movable electrode includes an insulating layer, a first conductive layer formed on a side where one surface of the insulating layer is present, and a second conductive layer formed on a side where another surface of the insulating layer is present; the AC input voltage is applied between the first fixed electrode and the first conductive layer; and the AC output voltage is extracted between the second fixed electrode and the second conductive layer.

According to the 4th aspect of the present invention, in the electrostatic transformer according to the 1st aspect, it is preferred that when an electrode surface of the movable electrode facing opposite the first fixed electrode, among the electrode surfaces of the movable electrode, takes on a flat electrode structure that allows a distance between the first fixed electrode and the movable electrode to be varied and the second fixed electrode is formed as a comb teeth electrode, an electrode surface facing opposite the second fixed electrode, among the electrode surfaces of the movable electrode, includes projecting poles, formed in a comb-tooth pattern, that engage with recessed portions of the second fixed electrode formed as the comb teeth electrode.

According to the 5th aspect of the present invention, in the electrostatic transformer according to the 1st aspect, it is preferred that when an electrode surface of the movable electrode facing opposite the first fixed electrode, among the electrode surfaces of the movable electrode, takes on a flat electrode structure that allows a distance between the first fixed electrode and the movable electrode to be varied, a first high dielectric constant layer is disposed within a space between the first fixed electrode and the movable electrode and a second high dielectric constant layer is disposed within a space between the second fixed electrode and the movable electrode.

According to the 6th aspect of the present invention, in the electrostatic transformer according to the 1st aspect, it is preferred that when an electrode surface of the movable electrode facing opposite the first fixed electrode, among the electrode surfaces of the movable electrode, takes on a comb teeth electrode structure that allows the movable electrode to be displaced in parallel to the first fixed electrode and the second fixed electrode is formed as a comb teeth electrode, a comb teeth electrode assuming a specific shape is formed so as to face opposite the comb teeth electrode constituting the second fixed electrode, at an electrode surface facing opposite the second fixed electrode, among the electrode surfaces of the movable electrode.

According to the 7th aspect of the present invention, in the electrostatic transformer according to the 6th aspect, it is preferred that a frequency of the AC output voltage can be varied by changing a pitch of comb teeth at the comb teeth electrode constituting the second fixed electrode.

### BRIEF DESCRIPTION OF THE DRAWINGS

FIGS. 1A and 1B are respectively a plan view and a sectional view of an electrostatic transformer manufactured in embodiment 1.

FIG. 2 is a diagram illustrating the principle of the voltage transformation ratio achieved at the electrostatic transformer according to the present invention.

FIGS. 3A and 3B are respectively a plan view and a sectional view of an electrostatic transformer achieved as variation 1 of embodiment 1.

FIGS. 4A and 4B are respectively a plan view and a sectional view of an electrostatic transformer achieved as variation 2 of embodiment 1.

FIGS. 5A and 5B are respectively a plan view and a sectional view of an electrostatic transformer achieved as variation 3 of embodiment 1.

FIGS. 6A and 6B are respectively a plan view and a sectional view of an electrostatic transformer achieved as variation 4 of embodiment 1.

FIGS. 7A and 7B are respectively a plan view and a sectional view of an electrostatic transformer manufactured in embodiment 2.

FIGS. 8A and 8B are respectively a plan view and a sectional view of an electrostatic transformer achieved as variation 1 of embodiment 2.

FIGS. 9A and 9B are respectively a plan view and a sectional view of an electrostatic transformer manufactured in embodiment 3.

### DESCRIPTION OF PREFERRED EMBODIMENTS

The following is a detailed description of preferred embodiments of the present invention given in reference to drawings.

### Embodiment 1

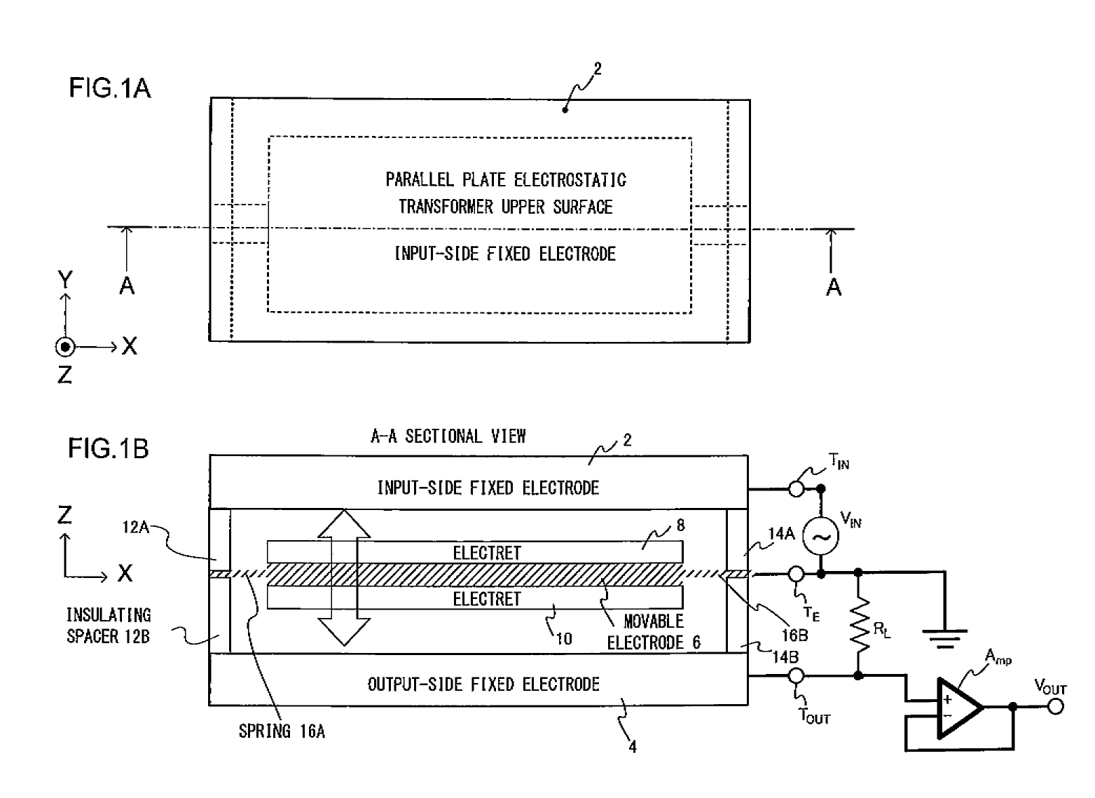

FIGS. 1A and 1B show an electrostatic transformer manufactured in embodiment 1, in a plan view (FIG. 1A) and a sectional view (FIG. 1B). It is to be noted that the dotted lines drawn in the plan view (FIG. 1A) indicate the positional relationships among a movable electrode 6, electrets 8 and 10 each constituted with a permanently charged film, springs 16A and 16B which are flexible members achieving electrical conductivity, and insulating spacers 12A, 12B, 14A and 14B, all shown in the sectional view (FIG. 1B).

As is obvious in the sectional view presented in FIG. 1B, the electrostatic transformer manufactured in embodiment 1 includes two sets of electrostatic actuators, each constituted with a parallel plate capacitor one stacked upon the other. Namely, a first electrostatic actuator (hereafter referred to as an input-side electrostatic actuator) is formed with an input-side fixed electrode 2 and the movable electrode 6 having the electret 8 disposed at an electrode surface thereof.

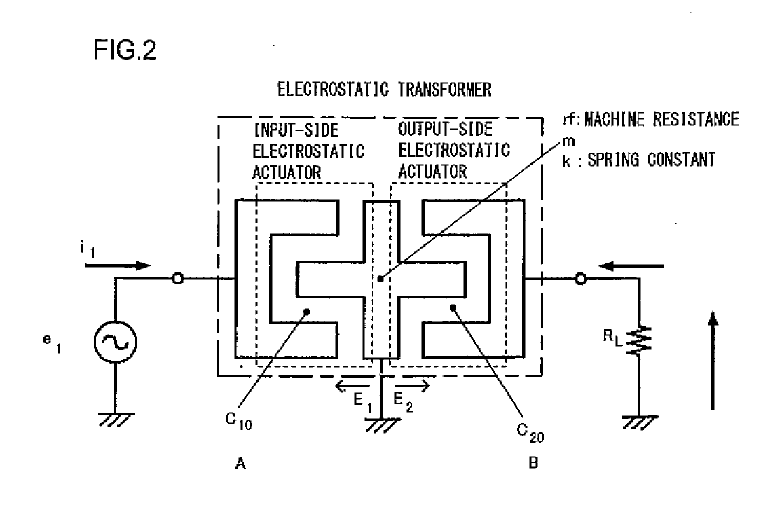

The movable electrode 6 is connected to an earth terminal T_{E} via the spring 16B. An AC input voltage V_{IN} is applied between the earth terminal T_{E} and an input terminal T_{IN}. In addition, through advance BT processing, the electret 8 is charged to a specific extent achieving a first charge quantity (e.g., equivalent to a potential of 210 V). Through these measures, it is an ensured that a first electromechanical coupling factor A is assumed at the input-side electrostatic actuator, as will be described later in reference to FIG. 2.

In addition, a second electrostatic actuator (hereafter referred to as an output-side electrostatic actuator) is formed with an output-side fixed electrode 2 and the movable electrode 6 having the electret 10 disposed at an electrode surface. Through advance BT processing, the electret 10 is charged to a specific extent achieving a second charge quantity (e.g., equivalent to a potential of 70 V). Through these measures, it is an insured that a second electromechanical coupling factor B is assumed at the output-side electrostatic actuator, as will be described later in reference to FIG. 2.

It is to be noted that the movable unit, constituted with the movable electrode 6 and the electrets 8 and 10, ideally, will be vacuum sealed so as to decrease the mechanical resistance (r_{f}) and increase the efficiency (η), as will be described later in reference to expression (6). In addition, the mechanical and electrical resonance frequency at the movable unit (i.e., the movable electrode 6 and the electrets 8 and 10) ideally will be adjusted to match the frequency of the AC input voltage V_{IN}.

In response to the application of the AC input voltage V_{IN}, the movable electrode 6 vibrates along a Z axis, and an electric charge is induced through electrostatic induction at the output-side fixed electrode 4 in the output-side electrostatic actuator. A load resistor R_{L} is connected between an output terminal T_{OUT} and the earth terminal T_{E} in order to obtain an output voltage based upon the electric charge induced at the output-side fixed electrode 4. The output terminal T_{OUT} is connected to the input end of a voltage follower Aₘₚ, and an AC output voltage V_{OUT} is obtained from the output end of the voltage follower Aₘₚ. As will be explained later in reference to FIG. 2, the voltage transformation ratio V_{OUT}/V_{IN} is determined as; “electromechanical coupling factor A at the input-side electrostatic actuate'÷“electromechanical coupling factor B at the output-side electrostatic actuator”. It is to be noted that under normal circumstances, a voltage follower that requires an external source with a voltage equal to or greater than the amplitude of the output voltage, cannot be utilized in a booster circuit. A structure that includes a voltage follower such as that shown in FIG. 1 is utilized for purposes of output impedance conversion in a test environment where an external source is available, and in practical application, a voltage follower is not utilized or a circuit that does not require a separate external source is utilized. This principle also applies to the structures shown in other figures that include a voltage follower.

The electrostatic transformer described above can be manufactured through a standard assembly technology without adopting the MEMS technology. In other words, an electrostatic transformer equipped with two sets of parallel plate electrostatic actuators can be configured by stacking the input-side fixed electrode 2 having a conductor (or a semiconductor layer), the output-side fixed electrode 4 having a conductor (or a semiconductor layer) and the movable electrode 6 with electrets, which includes a conductor (or a semiconductor layer) and is supported by the springs 16A and 16B where displacement occurs along the up/down direction (i.e., along the Z axis) in FIG. 1B, via the insulating spacers 12A, 12B, 14A and 14B.

It is not necessary that the input-side fixed electrode 2, the output-side fixed electrode 4 and the movable electrode 6 each constitute a conductor (or a semiconductor) in its entirety, and instead, they may each include a conductor (or semiconductor) layer formed by vapor-depositing a film onto an insulating base material. In addition, while the electrets 8 and 10 are formed at the surfaces of the movable electrode 6 in FIG. 1B, electrets (not shown) may be formed on surfaces of the input-side fixed electrode 2 and the output-side fixed electrode 4 in place of the electrets 8 and 10. Furthermore, the movable electrode 6 may be configured by using a thin-film spring (not shown).

In addition, although not shown in the figure, it is desirable to form an insulating protective film such as a hydrophobic film or a silicon nitride film at the surfaces of the electrets so as to protect the electric charges in the electrets.

While the overall size of the electrostatic transformer shown in FIGS. 1A and 1B, which is manufactured through assembly processes rather than assuming an integrated structure achieved through the MEMS technology, is bound to be large, such an electrostatic transformer is capable of handling greater power. In addition, the electrets can be formed in a batch by using, for instance, a commercially available resin product commonly used for electret production prior to the assembly processes. Furthermore, the spring structures in the electrostatic transformer, which can be manufactured by using a low-cost base material, assure a high level of durability and a greater amplitude, and as a result, the overall amount of dead space can be reduced.

FIG. 2 presents a diagram illustrating the principle of the voltage transformation ratio achieved at the electrostatic transformer according to the present invention. While the transformation ratio (V_{OUT}/V_{IN}), which is the ratio of the AC output voltage V_{OUT} to the AC input voltage V_{IN}, is calculated as “electromechanical coupling factor A at the input-side electrostatic actuator”÷“electromechanical coupling factor B at the output-side electrostatic actuator” as described earlier. The process through which this ratio is determined will be explained in reference to FIG. 2.

A widely known analytic theory among the analytic theories used in analysis of electrostatic actuators, is the comb teeth actuator (comb drive) analytic theory. In the comb teeth actuator analytic theory, a drive point matrix is expressed as follows, with X1 and X2 representing the initial comb teeth overlap distances, d1 and d2 representing the intervals between the comb teeth, b representing the thickness of the comb teeth, E1 and E2 representing the charge quantities (potentials) at the electrets, n1 and n2 representing the numbers of teeth (n=0.5 in a flat plate), A representing the electromechanical coupling factor at the input-side electrostatic actuator and B representing the electromechanical coupling factor at the output-side electrostatic actuator.

$$[ \begin{matrix}f \\ {i}_{1} \\ {i}_{2}\end{matrix} ] = [ \begin{matrix}Zm & - A & B \\ A & j ω {C}_{10} & 0 \\ - B & 0 & j ω {C}_{20}\end{matrix} ] [ \begin{matrix}v \\ {e}_{1} \\ {e}_{2}\end{matrix} ] \{ \begin{matrix}{C}_{10} = \frac{2 {n}_{1} {ɛ}_{0} b}{{d}_{1}} ( {X}_{1} + X ) \\ {C}_{20} = \frac{2 {n}_{2} {ɛ}_{0} b}{{d}_{2}} ( {X}_{2} - X )\end{matrix} \{ \begin{matrix}A = \frac{2 {n}_{1} {ɛ}_{0} {bE}_{1}}{{d}_{1}} \\ B = \frac{2 {n}_{2} {ɛ}_{0} {bE}_{2}}{{d}_{2}}\end{matrix} \qquad ( Operation Matrix Expression )$$

It is to be noted that the mechanical resistance r_{f} is set so that Zm=r_{f} on the assumption that resonance is achieved.

Expression (1), expression (2) and expression (3) below respectively indicate how the input current, the output current and the output voltage are calculated.

$$\begin{matrix}( Input Current ) & \\ {i}_{1} = \frac{( {A}^{2} - {ω}^{2} {C}_{10} {C}_{20} {R}_{L} {r}_{f} ) + j ω ( {A}^{2} {C}_{20} {R}_{L} + {C}_{10} {r}_{f} + {C}_{10} {B}^{2} {R}_{L} )}{{r}_{f} + {B}^{2} {R}_{L} + j ω {C}_{20} {R}_{L} {r}_{f}} \cdot {e}_{1} [ A ] & ( 1 ) \\ ( Output Current ) & \\ {i}_{2} = \frac{- AB}{{r}_{j} + {B}^{2} {R}_{L} + j ω {C}_{20} {R}_{L} {r}_{f}} \cdot {e}_{1} [ A ] & ( 2 ) \\ ( Output Voltage ) & \\ {e}_{2} = - {i}_{2} {R}_{L} = \frac{{ABR}_{L}}{{r}_{f} + {B}^{2} {R}_{L} + j ω {C}_{20} {R}_{L} {r}_{f}} \cdot {e}_{1} [ V ] & ( 3 ) \\ ( Effective Input Power ) & \\ {P}_{ir} = \frac{{r}_{f} {A}^{2} + {A}^{2} {B}^{2} {R}_{L} + {ω}^{2} {A}^{2} {C}_{20}^{2} {R}_{L}^{2} {r}_{f}}{{( {r}_{f} + {B}^{2} {R}_{L} )}^{2} + {( ω {C}_{20} {R}_{L} {r}_{f} )}^{2}} \cdot {e}_{1}^{2} [ W ] & ( 4 ) \\ ( Effective Output Power ) & \\ {P}_{or} = \frac{{A}^{2} {B}^{2} {R}_{L}}{{( {r}_{f} + {B}^{2} {R}_{L} )}^{2} + {( ω {C}_{20} {R}_{L} {r}_{f} )}^{2}} \cdot {e}_{1}^{2} [ W ] & ( 5 )\end{matrix}$$

The following expressions (9) and (10) are obtained based upon expression (1), expression (2) and expression (3). Expression (10) in particular, which expresses the voltage transformation ratio (V_{OUT}/V_{IN}) at the electrostatic transformer, indicates that the ratio of the AC output voltage V_{OUT} to the AC input voltage V_{IN} is determined by the ratio of the “electromechanical coupling factor A at the input-side electrostatic actuator” and the “electromechanical coupling factor B at the output-side electrostatic actuator”.

$$\begin{matrix}( Efficiency ) & \\ η = \frac{{P}_{or}}{{P}_{ir}} = \frac{{B}^{2} {R}_{L}}{{r}_{f} + {B}^{2} {R}_{L} + {ω}^{2} {C}_{20}^{2} {R}_{L}^{2} {r}_{f}} \times 100 [ \% ] & ( 6 ) \\ ( Velocity ) & \\ v = \frac{{Ar}_{f} + {AB}^{2} {R}_{L} - {AB}^{2} {R}_{L} {r}_{f} + j ω {C}_{20} {R}_{L} {Ar}_{f}}{{r}_{f}^{2} + {B}^{2} {R}_{L} {r}_{f} + j ω {C}_{20} {R}_{L} {r}_{f}^{2}} \cdot {e}_{1} [ m \text{/} s ] & ( 7 ) \\ ( Displacement ) & \\ x = \frac{{Ar}_{f} + {AB}^{2} {R}_{L} - {AB}^{2} {R}_{L} {r}_{f} + j ω {C}_{20} {R}_{L} {Ar}_{f}}{- {ω}^{2} {C}_{20} {R}_{L} {r}_{f}^{2} + j ω ( {r}_{f}^{2} + {B}^{2} {R}_{L} {r}_{f} )} \cdot {e}_{1} [ m ] & ( 8 ) \\ ( Amplification Rate ) & \\ \begin{matrix}G = \frac{{e}_{2}}{{e}_{1}} \\ = \frac{{ABR}_{L}}{{r}_{f} + {B}^{2} {R}_{L} + j ω {C}_{20} {R}_{L} {r}_{f}} \\ = \frac{A}{B \{ 1 + \frac{{r}_{f}}{{B}^{2}} ( \frac{1 + j ω {C}_{20} {R}_{L}}{{R}_{L}} ) \}} ( 10 ) \\ \approx \{ ∵ 1 >> \frac{{r}_{f}}{{B}^{2}} ( \frac{1 + j ω {C}_{20} {R}_{L}}{{R}_{L}} ) \}\end{matrix} & ( 9 )\end{matrix}$$

In addition, as expression (6) for the efficiency η clearly indicates, η=100% when the mechanical resistance r_{f} is 0. Accordingly, it is most desirable to vacuum seal the movable electrode 6, as has been explained earlier.

### Variation 1 of Embodiment 1

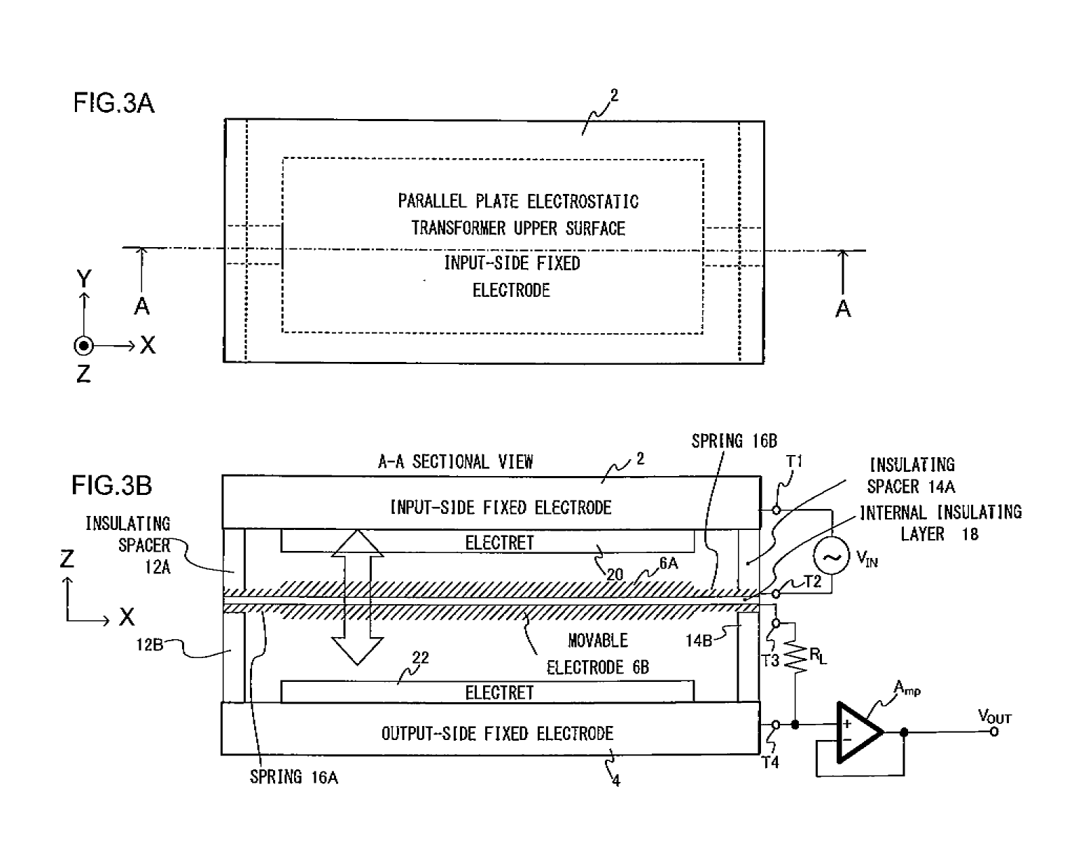

FIGS. 3A and 3B show an electrostatic transformer achieved as variation 1 of embodiment 1 in a plan view (FIG. 3A) and a sectional view (FIG. 3B). While the electrostatic transformer described earlier in reference to FIGS. 1A and 1B adopts a three-terminal structure with a common potential provided at the movable electrode 6, the electrostatic transformer achieved in this variation includes an insulating layer formed inside the movable electrode so as to isolate the input side and the output side from each other. Namely, an internal insulating layer 18 is present between a movable electrode 6A and a movable electrode 6B, as shown in FIG. 3B.

The AC input voltage V_{IN} is applied between the movable electrode 6A and the input-side fixed electrode 2 via a terminal T1 and a terminal T2. The AC output voltage V_{OUT} is extracted between the movable electrode 6B and the output-side fixed electrode 4 via a terminal T3 and a terminal T4. It is to be noted that while an electret 20 and an electret 22 are respectively disposed at the input-side fixed electrode 20 and at the output side 60 electrode 4 in the structure shown in FIG. 3B, electrets may be disposed at surfaces of the movable electrodes 6A and 6B in place of the electrets 20 and 22 (as in FIG. 1B). Other structural elements and the operations thereof are identical to those described in reference to FIG. 1.

By adopting the structure shown in FIGS. 3A and 3B, a four-terminal electrostatic transformer having an isolation function is achieved. It is to be noted that depending upon the purposes of use, the terminal T2 and the terminal T3 may be connected so as to utilize it as a three-terminal electrostatic transformer.

As is the case in the structure described in reference to FIGS. 1A and 1B, it is desirable to form an insulating protective film such as a hydrophobic film or a silicon nitride film at the surfaces of the electrets so as to protect the electric charges in the electrets. In addition, while the overall size of the electrostatic transformer shown in FIGS. 3A and 3B, which is manufactured through assembly processes rather than assuming an integrated structure achieved through the MEMS technology, is bound to be large, such an electrostatic transformer is capable of handling greater power. The electrets can be formed in a batch by using, for instance, a commercially available resin product commonly used for electret production prior to the assembly processes. Furthermore, the spring structures in the electrostatic transformer, which can be manufactured by using low-cost base material, assure a high level of durability and a greater amplitude, and as a result, the amount of dead space can be reduced.

### Variation 2 of Embodiment 1

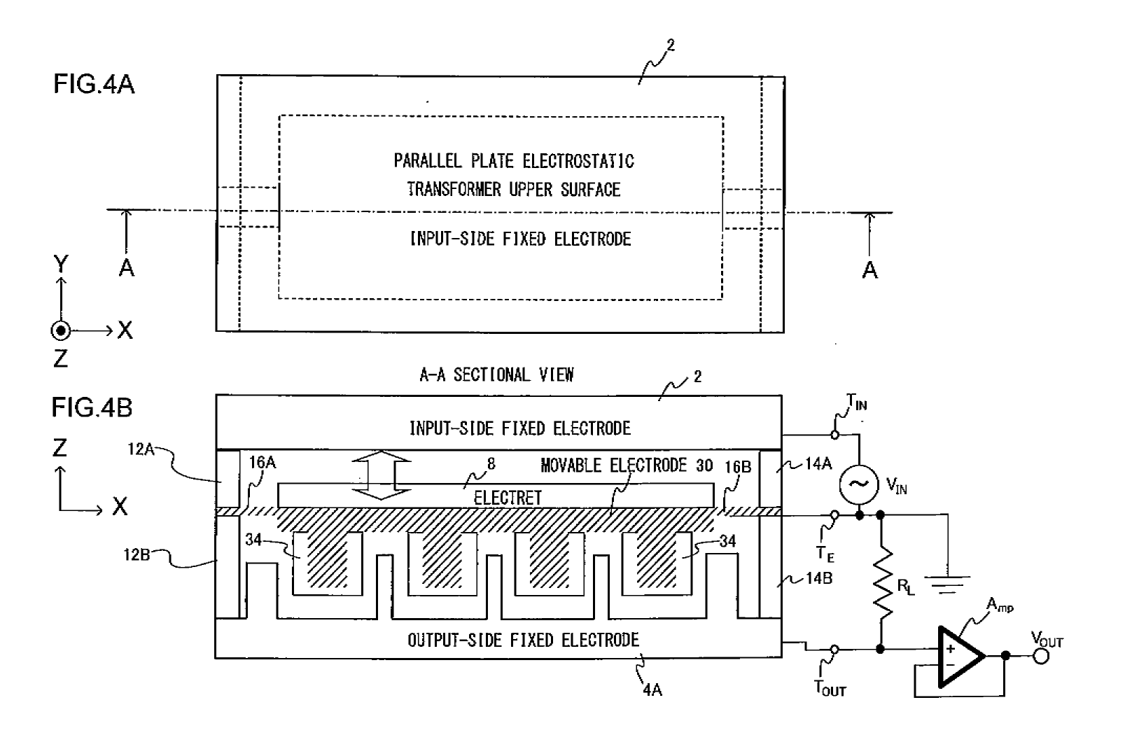

FIGS. 4A and 4B show an electrostatic transformer achieved as variation 2 of embodiment 1 in a plan view (FIG. 4A) and a sectional view (FIG. 4B). While the electrets 8 and 10 are disposed at the two electrode surfaces of the movable electrode 6 in the structure described earlier in reference to FIG. 1B, the electrostatic transformer achieved in this variation includes electrets 34 disposed in a comb-tooth formation, in place of the electret 10. Namely, a movable electrode 30 in FIG. 4B is not a simple flat plate as is the movable electrode 6 in FIG. 1B, and instead adopts a shape that includes a flat electrode surface facing opposite the input-side fixed electrode 2 and an electrode surface facing opposite an output-side fixed electrode 4A, at which projecting portions are formed in a comb-tooth pattern.

The output-side fixed electrode 4A, facing opposite the projecting portions of the movable electrode 30, is a comb teeth electrode (or a comb electrode) with recessed portions formed over predetermined intervals, which engage with the projecting portions over a predetermined gap. Thus, as the movable electrode 30 vibrates along the up/down direction (i.e., along the Z axis) in FIG. 4B, an electric charge is induced at the output-side fixed electrode 4A formed as a comb teeth electrode and, as a result, an output voltage V_{OUT} is extracted via the voltage follower Aₘₚ. Other structural elements and the operations thereof are identical to those described in reference to FIGS. 1A and 1B.

In more specific terms, the recess/projection pattern at the movable electrode 30 and the comb structure at the output-side fixed electrode 4A shown in FIG. 4B can each be achieved by forming holes in metal sheets through etching or punching, laminating the metal sheets and bonding them together through crimping or via a conductive adhesive. As an alternative, an electrode constituted with a glass plate sandblasted or the like so as to form a recess/projection comb-tooth pattern with a conductive film vapor deposited upon a surface thereof, may be used. It is to be noted that the comb teeth at the electrodes do not need extend in a uniform stripe pattern, and they may instead be formed so as to achieve a staggered pattern.

While the electrets 8 and 34 are formed on the electrode surfaces at the movable electrode 30 in the structure shown in FIG. 4B, electrets may instead be disposed at the input-side fixed electrode 2 and the output-side fixed electrode 4A (not shown) in place of these electrets 8 and 34. In other words, electrets simply need to be present either at the movable electrode or at the fixed electrodes. It is to be noted that while an electret is commonly formed by coating a surface with a dielectric resin and inducing a permanent charge through corona discharge, it may instead be formed during an assembly step by pasting a silicon oxide film containing alkali ions onto a surface.

### Variation 3 of Embodiment 1

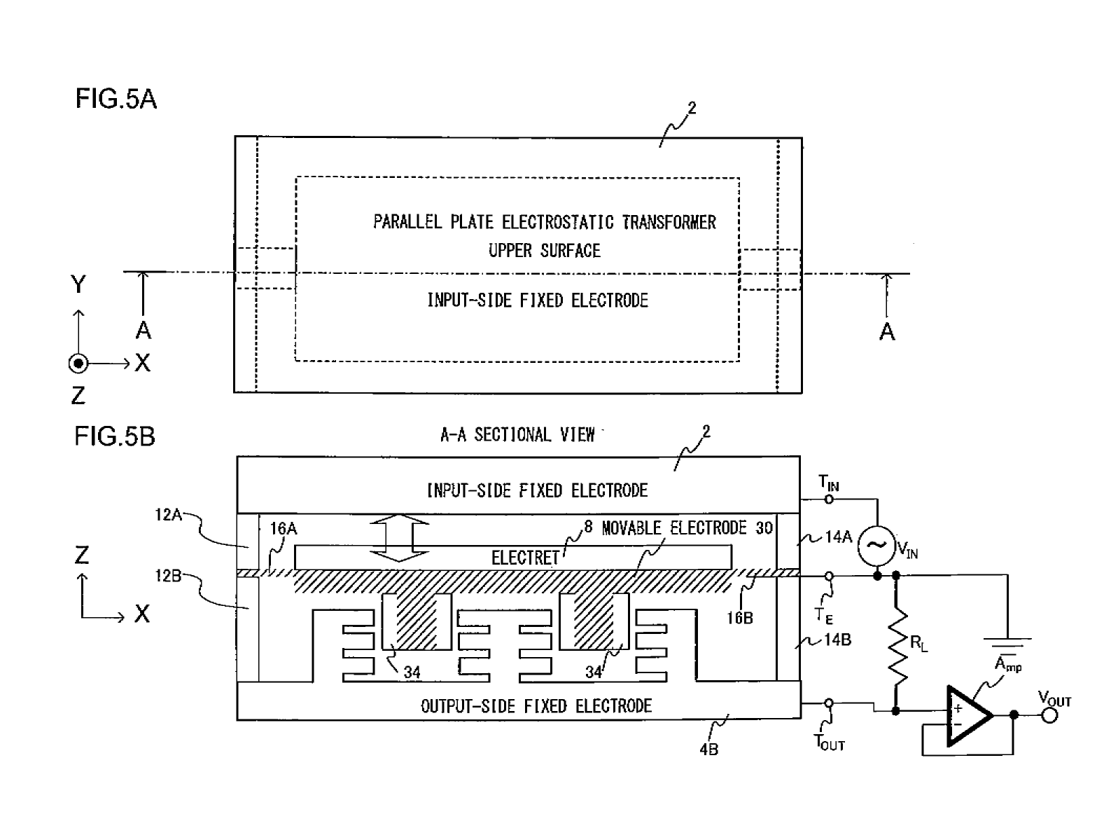

FIGS. 5A and 5B show an electrostatic transformer achieved as variation 3 of embodiment 1 in a plan view (FIG. 5A) and a sectional view (FIG. 5B). The output-side fixed electrode in the electrostatic transformer shown in these figures is distinguishable from the output-side fixed electrode 4A described earlier in reference to FIG. 4B in that it includes projecting portions formed thereat in a comb-tooth pattern, each having a plurality of projecting portions and recessed portions formed at a side surface thereof. Namely, the projecting portions at the output-side fixed electrode 4B in the figure are different from the projecting portions (i.e., comb teeth) at the output-side fixed electrode 4A described earlier in reference to FIG. 4B in that a reiterative recess/projection pattern (i.e., recesses and projections along the X axis) is formed along the Z axis at side surfaces thereof so that a recess is followed by a projection in an alternating pattern along the Z axis.

As the movable electrode 30 vibrates along the up/down direction (i.e., along the Z axis), the electrets 34 disposed at the movable electrode 30 move into and out of the recessed portions of the output-side fixed electrode 4B while maintaining a predetermined clearance. As a result, while each electret 34 moves back and forth through the corresponding recessed portion of the output-side fixed electrode 4B once, it passes by a plurality of comb teeth portions (i.e., portions recessed/projecting along the X axis). Since the electric charge induced at the output-side fixed electrode 4B increases or decreases each time the electrets 34 each pass by a comb tooth portion, the voltage increases/decreases a plurality of times while the electrets move back and forth through the recessed portions once, as described above. Through this process, the frequency of the AC output voltage V_{OUT} becomes raised relative to the frequency of the AC input voltage V_{IN}. In other words, the electrostatic transformer shown in FIGS. 5A and 5B fulfills a function of frequency conversion as well as a voltage conversion function defined by the voltage transformation ratio.

The output-side fixed electrode 4B with projecting comb teeth portions shown in FIG. 5B, may be formed by for instance, laminating metal sheets with holes of various sizes formed therein.

In addition, when a standard electrostatic transformer known in the related art is to fulfill a voltage boosting function, the output-side electromechanical coupling factor (B in expression (10)) must be lowered. Under such circumstances, there will be a limit to the extent to which the electrostatic capacity can be raised and it will be difficult to lower the output impedance. However, the structure illustrated in FIGS. 5A and 5B allows the frequency to be raised even when the electrostatic capacity is low, and this, in turn, makes it possible to lower the output impedance.

### Variation 4 of Embodiment 1

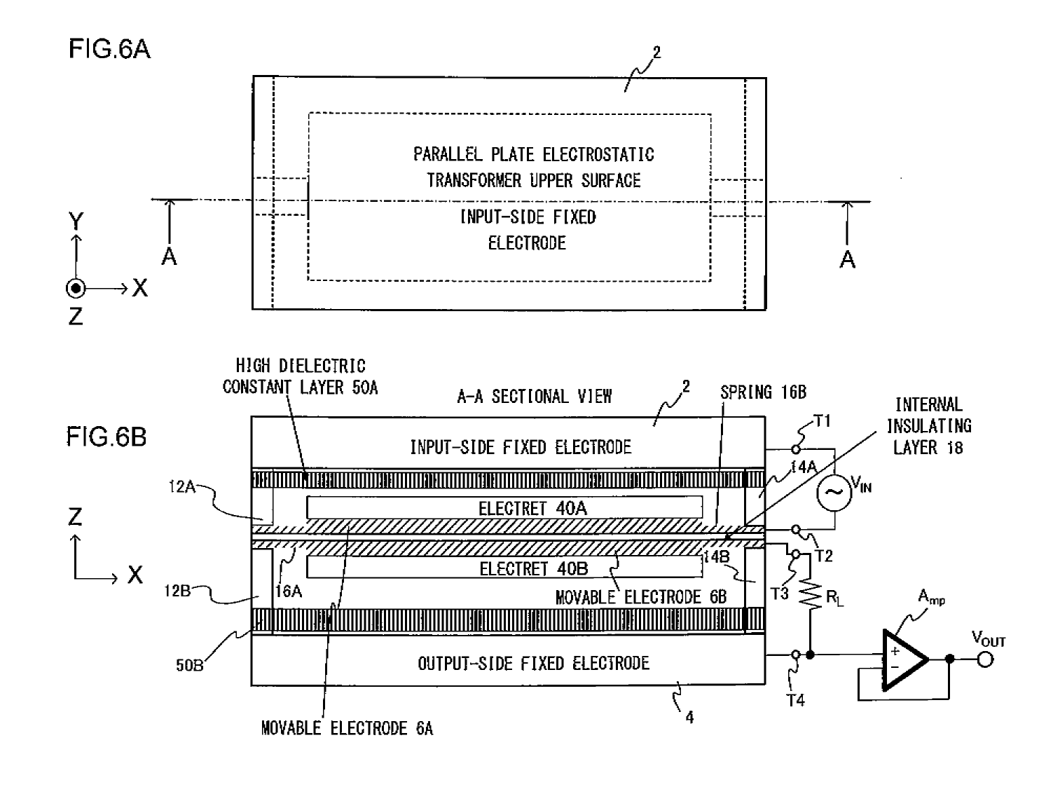

FIGS. 6A and 6B show an electrostatic transformer achieved as variation 4 of embodiment 1 in a plan view (FIG. 6A) and a sectional view (FIG. 6B). The electrostatic transformer shown in the figures, achieved by modifying the electrostatic transformer described earlier in reference to FIGS. 1A and 1B, includes an internal insulating layer 18 (see FIG. 3B) disposed within the movable electrode so as to allow it to be used in a four-terminal transformer and further includes dielectric layers 50A and 50B each achieving a high dielectric constant, inserted therein so as to increase the electrostatic capacity.

By inserting the high dielectric constant layers 50A and 50B in the gaps, one present on the side where the input-side electrostatic actuator is located and another present on the side where the output-side electrostatic actuator is located, the electrostatic capacity can be increased as described above. For instance, the presence of dielectric layers formed by using a material with a very high dielectric constant such as barium titanate makes it possible to raise the electrostatic capacity to a level far above the standard level. It is to be noted that such a high dielectric constant layer only needs to fill part of the space present between a fixed electrode and the movable electrode, and does not need to be formed as a film layered upon either electrode.

In addition, while the high dielectric constant layers 50A and 50B are inserted via the insulating spacers 12A, 12B, 14A and 14B in the structural example presented in FIG. 6B, a high dielectric constant layer constituted of an insulating material may be directly formed onto a fixed electrode or the movable electrode. Furthermore, while the optimal base materials to be used when forming high dielectric constant layers through the MEMS technology are silicon, titanium oxide and the like, high dielectric constant layers in an electrostatic transformer manufactured through assembly processes may be formed with another material.

High dielectric constant materials that may be used when forming the high dielectric constant layers include vinyl chloride, glass, graphite plate, barium titanate and Rochelle salt. In addition, it is desirable and thus more likely that the electrostatic transformer will be utilized in the form of a low/reduced pressure package in order to assure high power conversion efficiency. The high dielectric constant layers included in such a low/reduced pressure package can be formed with a material that is vulnerable to exposure to the atmosphere or moisture.

### Embodiment 2

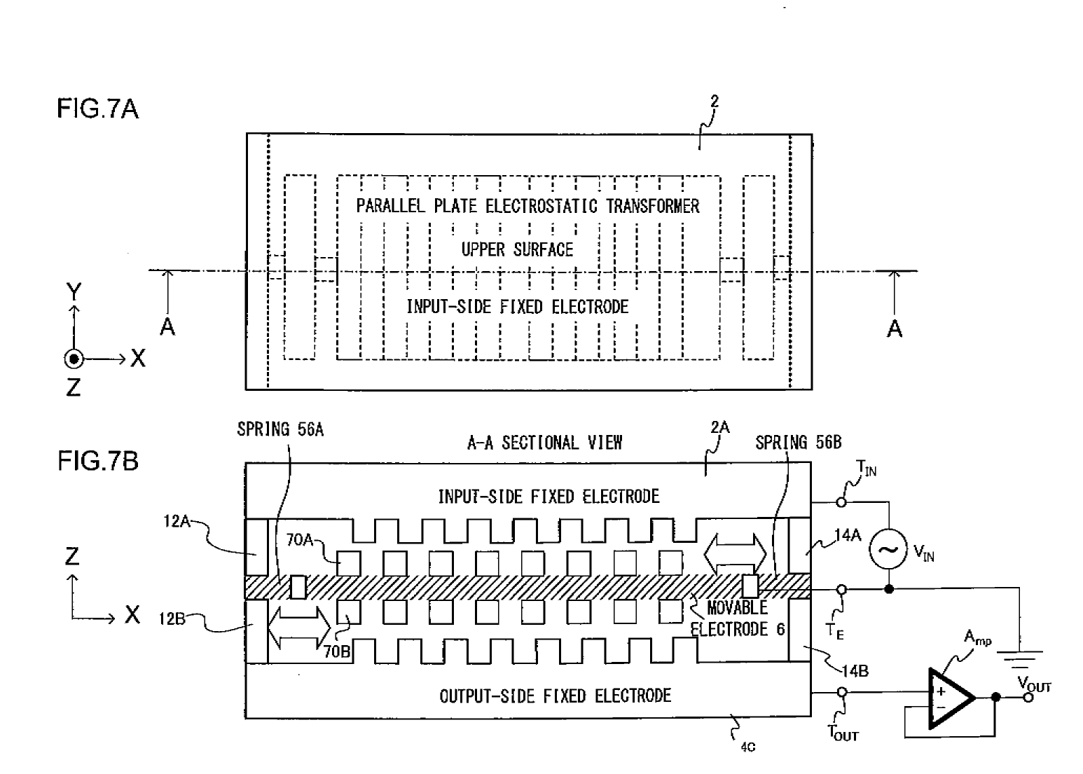

FIGS. 7A and 7B show an electrostatic transformer manufactured in embodiment 2, in a plan view (FIG. 7A) and a sectional view (FIG. 7B). Embodiment 2, which is to be described below, is distinguishable from embodiment 1 described above in that the movable electrode 6 vibrates along the lateral direction (along the X axis). In order to enable lateral vibration, recessed/projecting portions in a uniform stripe pattern (commonly referred to as salient poles) are formed at a fixed electrode surface at the input-side electrostatic actuator, a fixed electrode surface at the output-side electrostatic actuator and each movable electrode surface. In other words, the fixed electrode surface at the input-side electrostatic actuator, the fixed electrode at the output-side electrostatic actuator and the movable electrode each achieve a comb teeth electrode structure.

As FIG. 7B shows, an input-side fixed electrode 2A, an output-side fixed electrode 4C and the movable electrode 6 are stacked one on top of another via the insulating spacers 12A, 12B, 14A and 14B and electrets 70A and 70B are formed at the two surfaces of the movable electrodes 6. In this regard, the electrostatic transformer in this embodiment is similar to that shown in FIGS. 1A and 1B. However, since the movable electrode 6 vibrates along the lateral direction (i.e., along the X axis) instead of along the up/down direction (i.e., along the Z axis), it is bound to include structural elements different from those in the electrostatic transformer shown in FIGS. 1A and 1B. Furthermore, the projecting portions formed at the fixed electrode surfaces of the input-side electrostatic actuator and the output-side electrostatic actuator and the electrets projecting at the movable electrode surfaces are positioned so that the projecting portions and the electrets facing opposite the projecting portions are offset by an extent substantially equal to half of the width of a projecting portion in the initial state.

It is to be noted that recesses and projections may be formed at the electrode surfaces of the movable electrode and electrets may be formed at such electrode surfaces. In addition, electrets may be disposed at the fixed electrodes, instead.

As an AC input voltage V_{IN} is applied to the input-side electrostatic actuator, the movable electrode 6 moves toward a point at which maximum stability is achieved based upon the potential attributable to the combination of the potential difference created via the electrets 70A and the AC voltage, and the spring force imparted from the springs 50A and 56B. In other words, the greater the potential difference, the closer the movable electrode 6 moves toward a state in which the comb teeth portions face exactly opposite each other. The crucial point here is that since the factor affecting the displacement of the movable electrode 6 is not the positivity/negativity of the potential but rather the potential difference, the movable electrode 6 vibrates with a frequency twice that of the AC input voltage V_{IN}.

The springs 56A and 56B should be prepared so as to ensure that they remain rigid against displacement along the vertical direction (i.e., along the Z axis) and yield to displacement along the horizontal direction (i.e., along the X axis). In conjunction with such springs 56A and 56B, the movable electrode 6 is allowed to vibrate substantially along the horizontal direction (i.e., along the X axis) in response to application of the AC input voltage V_{IN}.

By adopting a recess/projection structure similar to that at the input-side electrostatic actuator, for the output-side electrostatic actuator as well, the functions of an electrostatic transformer are fulfilled. It is to be noted that the widths and pitches of the recessed/projecting portions at the input-side electrostatic actuator and the output-side electrostatic actuator may be set by allowing the output-side electrostatic actuator to assume higher density (or lower density) and, in such a case, the frequency of the AC output voltage V_{OUT} extracted via the voltage follower Aₘₚ can be altered. As an alternative, the vibration amplitude along the horizontal direction (i.e., along the X axis) may be increased by disposing horizontal drive electrostatic actuators, one on the left side and the other on the right side (not shown) within the same plane in which the movable electrode 6 is disposed.

### Variation 1 of Embodiment 2

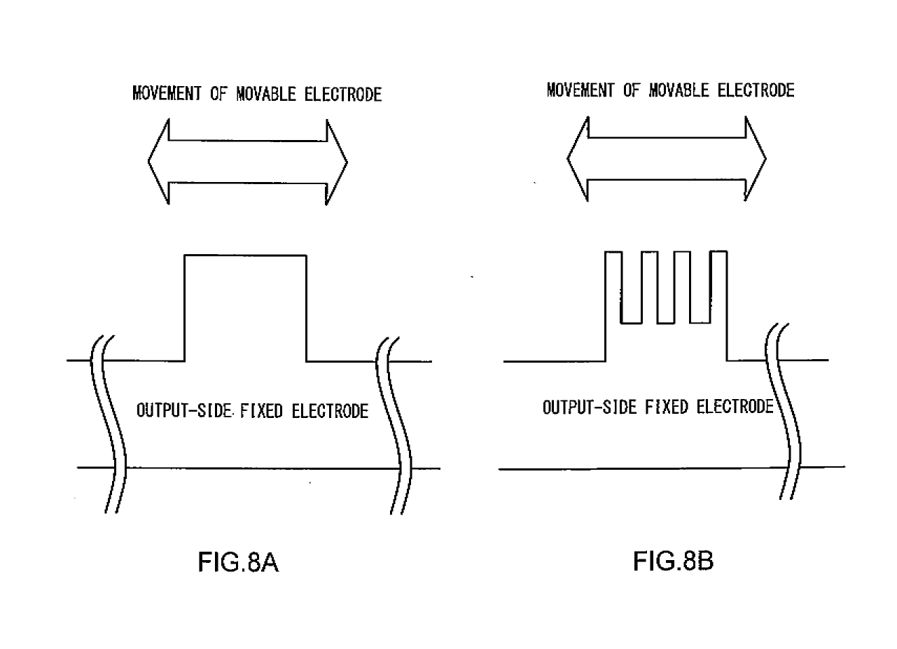

FIGS. 8A and 8B illustrate variation 1 of embodiment 2. FIG. 8A presents an enlargement of a projecting portion at the output-side fixed electrode 4C in FIG. 7B. Variation 1 of embodiment 2, to be described next, is distinguishable in that a plurality of comb teeth are formed at each projecting portion, as shown in FIG. 8B, at the output-side fixed electrode.

In variation 1 shown in FIG. 8B, a positional relationship identical to the positional relationship between the movable electrode 30 and the output-side fixed electrode 4B shown in FIG. 5B is adopted. Namely, as the movable electrode 6 shown in FIG. 7B vibrates along the lateral direction (i.e., along the X axis) the electric charge induced at the output-side fixed electrode 4C increases/decreases each time the electrets 70B each pass by a comb tooth portion, which allows the AC output voltage V_{OUT} to assume a frequency higher than the frequency of the AC input voltage V_{IN}. Namely, the electrostatic transformer fulfills a function of frequency conversion as well as a voltage conversion function defined by the voltage transformation ratio.

In addition, when a standard electrostatic transformer known in the related art is to fulfill a voltage boosting function, the output-side electromechanical coupling factor (B in expression (10)) must be lowered. Under such circumstances, there will be a limit to the extent to which the electrostatic capacity can be raised and it will be difficult to lower the output impedance. However, the structure illustrated in FIGS. 7A and 7B allows the frequency to be raised even when the electrostatic capacity is low, and this, in turn, makes it possible to lower the output impedance.

### Embodiment 3

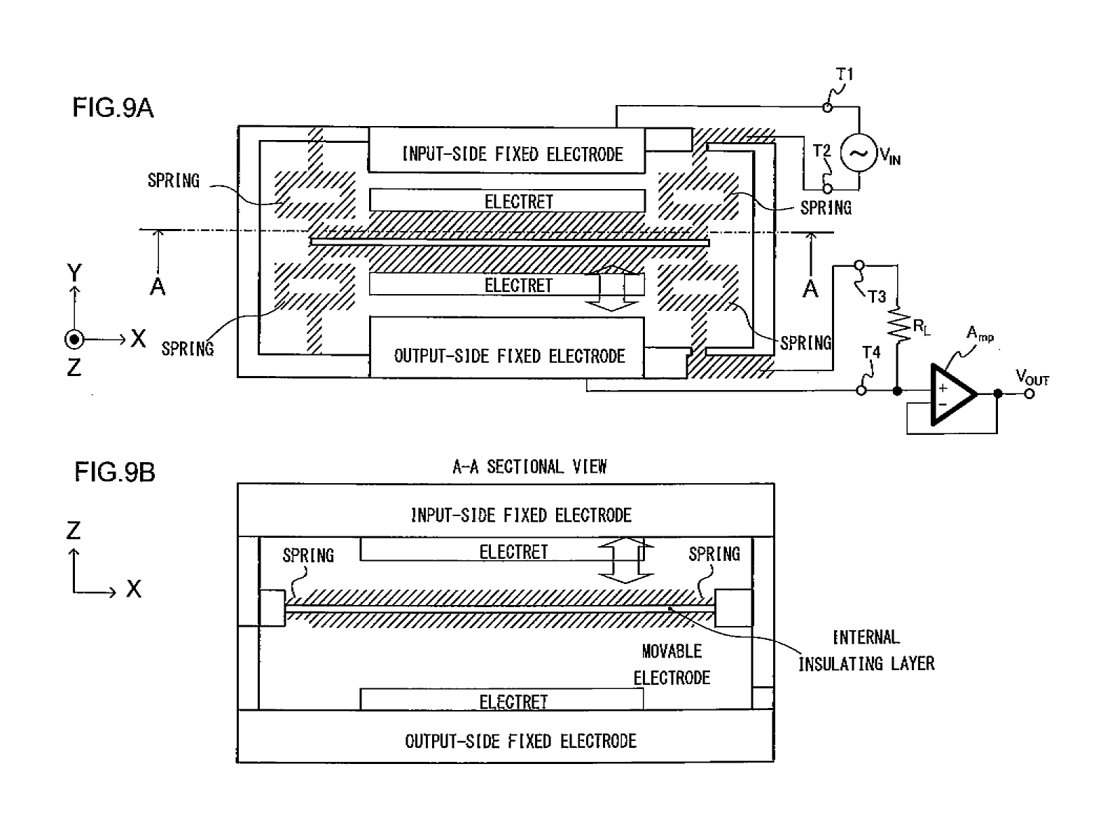

FIGS. 9A and 9B show an electrostatic transformer manufactured in embodiment 3, in a plan view (FIG. 9A) and a sectional view (FIG. 9B). The electrostatic transformer to be described next represents a type of electrostatic transformer adopting a structure that allows vibration both along the horizontal direction (i.e., along the X axis) and along the vertical direction. In the electrostatic transformer shown in FIGS. 1A and 1B, for instance, vibration occurs substantially along a single axis, namely in the up/down direction (i.e., along the Z axis), whereas in the electrostatic transformer shown in FIGS. 7A and 7B, vibration occurs only in the left/right direction (i.e., along the X axis). These electrostatic transformers each assume at least one resonance mode and each operate as an electrostatic transformer primarily by using the resonance frequency.

The electrostatic transformer in this embodiment, on the other hand, assumes two vibration modes, i.e., a vertical direction vibration mode (Z axis vibration mode) and a horizontal direction vibration mode (X axis vibration mode). For this reason, electrets are formed at the side surfaces of the movable electrode and also at the fixed electrodes. Furthermore, the electrets are formed at the side surfaces of the fixed electrodes, too.

The springs are formed so that they are allowed to move readily both along the horizontal direction and along the vertical direction. In addition, it is ensured that different resonance frequencies are assumed in the two vibration modes. By switching to a different resonance frequency and correspondence to the selected vibration mode, the output impedance or the transformation ratio can be switched. While the voltage transformation ratio may be switched by, for instance, splitting the fixed electrodes into smaller segments and disposing a switch at a succeeding stage so as to either combine outputs or allow the outputs to remain separate, some portion of the output will remain unused and thus waste is inevitable in the structure. The structure achieved in this embodiment, in contrast, eliminates such waste. While it will be obvious that an electrostatic transformer may simply assume the horizontal vibration mode only with no electrets or electrodes formed in the plane, such an electrostatic transformer will be better manufactured in a batch through the MEMS technology, which facilitates high density formation.

The electrostatic transformer in embodiment 3 is advantageous, as are the electrostatic transformers described so far, in that it allows a plurality of layers to be laminated one on top of another. It is to be noted that the layers may be laminated by adopting any of various methods including pressure bonding as well as anodic bonding and metal bonding.

In addition, in another mode of the present invention, a specific part of a fixed electrode may function as a movable electrode. Namely, the present invention may be adopted in a structure affording freedom of movement for the top and bottom electrodes, so as to allow them to vibrate along the vertical direction and affording freedom of movement for the central electrode so as to allow it to vibrate along the left/right direction.

### Operations and Advantageous Effects of the Embodiments

The following is a list of operations and advantageous effects achieved through the embodiments of the present invention.
(1) The structure is simple and it allows the electrostatic transformer to be manufactured through assembly processes.
(2) A large electrostatic transformer can be manufactured and there is no need for miniaturization.
(3) A material that has robust impact withstanding properties can be selected.
(4) An optimal material can be selected for the springs so as to increase the extent of vibration.

These operations and advantageous effects make it possible to provide a high-output electrostatic transformer without raising the manufacturing costs.

It is to be noted that since the application range for the present invention is not limited to electrostatic transformers adopting a comb-tooth structure achieved through the MEMS technology and having alkali ion-containing inorganic electrets, problems such as:

structural complexity;

restrictions imposed on the size or the extent of miniaturization by the silicon wafer size and the performance level of the MEMS manufacturing apparatus;

vulnerability to impact shock inherent in a brittle material such as an Si-based material; and

limit to the extent of vibration imposing a limit to signal dynamic range, can be prevented.

Namely, the electrostatic transformers achieved in the embodiments described above, each assuming a simple structure configured with two sets of electrostatic actuators stacked one on top of the other without requiring the MEMS technology, can be assembled as a high-output electrostatic transformers with materials the manufacturer deems desirable without resulting in any increase in the manufacturing costs.

It is to be noted that the embodiments and variations described above simply represent examples and the present invention is in no way limited to these examples as long as the features characterizing the present invention remain intact. An embodiment may be adopted with a single variation or in combination with a plurality of variations. Variations may be adopted in any conceivable combination. In addition, any other mode conceivable within the technical range of the present invention should be considered to be within the scope of the present invention.

What is claimed is:

1. An electrostatic transformer, comprising:
a first fixed electrode;
a second fixed electrode disposed at a position facing opposite the first fixed electrode;
a movable electrode displaceably supported by a flexible member within a space between the first fixed electrode and the second fixed electrode; and
permanently charged films disposed on electrode surfaces of the movable electrode or disposed at the first fixed electrode and at the second fixed electrode, wherein:
an AC output voltage corresponding to a change in an electric charge induced at the second fixed electrode by displacing the movable electrode in response to an AC input voltage applied between the first fixed electrode and the movable electrode is extracted; and
a ratio of the AC input voltage and the AC output voltage is determined based upon a ratio of an electromechanical coupling factor at an input-side electrostatic actuator, configured with the first fixed electrode and the movable electrode, and an electromechanical coupling factor at an output-side electrostatic actuator, configured with the second fixed electrode and the movable electrode.

2. An electrostatic transformer according to claim 1, wherein:
an electrode surface facing opposite the first fixed electrode, among the electrode surfaces of the movable electrode, takes on either a flat electrode structure that allows a distance between the first fixed electrode and the movable electrode to be varied or a comb teeth electrode structure that allows the movable electrode to be displaced parallel to the first fixed electrode.

3. An electrostatic transformer according to claim 2, wherein:
the movable electrode includes an insulating layer, a first conductive layer formed on a side where one surface of the insulating layer is present, and a second conductive layer formed on a side where another surface of the insulating layer is present;
the AC input voltage is applied between the first fixed electrode and the first conductive layer; and
the AC output voltage is extracted between the second fixed electrode and the second conductive layer.

4. An electrostatic transformer according to claim 1, wherein:
when an electrode surface of the movable electrode facing opposite the first fixed electrode, among the electrode surfaces of the movable electrode, takes on a flat electrode structure that allows a distance between the first fixed electrode and the movable electrode to be varied and the second fixed electrode is formed as a comb teeth electrode, an electrode surface facing opposite the second fixed electrode, among the electrode surfaces of the movable electrode, includes projecting poles, formed in a comb-tooth pattern, that engage with recessed portions of the second fixed electrode formed as the comb teeth electrode.

5. An electrostatic transformer according to claim 1, wherein:
when an electrode surface of the movable electrode facing opposite the first fixed electrode, among the electrode surfaces of the movable electrode, takes on a flat electrode structure that allows a distance between the first fixed electrode and the movable electrode to be varied, a first high dielectric constant layer is disposed within a space between the first fixed electrode and the movable electrode and a second high dielectric constant layer is disposed within a space between the second fixed electrode and the movable electrode.

6. An electrostatic transformer according to claim 1, wherein:
when an electrode surface of the movable electrode facing opposite the first fixed electrode, among the electrode surfaces of the movable electrode, takes on a comb teeth electrode structure that allows the movable electrode to be displaced in parallel to the first fixed electrode and the second fixed electrode is formed as a comb teeth electrode, a comb teeth electrode assuming a specific shape is formed so as to face opposite the comb teeth electrode constituting the second fixed electrode, at an electrode surface facing opposite the second fixed electrode, among the electrode surfaces of the movable electrode.

7. An electrostatic transformer according to claim 6, wherein:
a frequency of the AC output voltage can be varied by changing a pitch of comb teeth at the comb teeth electrode constituting the second fixed electrode.
